(19) United States
(12) Patent Application Publication
(10) Pub. No.: US 2020/0207670 A1
(43) Pub. Date: Jul. 2, 2020

(54) HYBRID FOAM

(71) Applicant: BASF SE, Ludwigshafen am Rhein (DE)

(72) Inventors: Ekkehard JAHNS, Ludwigshafen (DE); Fabian NIEDERMAIR, Trostberg (DE); Alexander CENTNER, Ludwigshafen (DE); Georg DAXENBERGER, Trostberg (DE)

(73) Assignee: BASF SE, Ludwigshafen am Rhein (DE)

(21) Appl. No.: 16/634,600

(22) PCT Filed: Aug. 10, 2018
(86) PCT No.: PCT/EP2018/071735

§ 371 Date: Jan. 28, 2020

(30) Foreign Application Priority Data
Aug. 23, 2017 (EP) 17187564.4

(51) Int. Cl. C04B 38/10; C04B 28/02; C04B 24/38; C04B 24/26; C04B 24/28; C04B 24/16

(52) U.S. Cl. CPC C04B 38/10; C04B 28/02; C04B 24/383; C04B 2103/44; C04B 24/2676; C04B 24/282; C04B 24/16; C04B 24/2635

(57) ABSTRACT

The present invention relates to a hybrid foam, to a process for producing a hybrid foam and a hybrid foam obtainable by this process and to the use of the hybrid foam for adhesive bonding, filling and/or insulating.

The present invention relates to a hybrid foam, to a process for producing a hybrid foam and a hybrid foam obtainable by this process and to the use of the hybrid foams according to the invention for bonding, filling and/or insulating.

Cementitious foams have numerous applications in the construction industry, for example as an insulation material.

However, on account of their brittleness cementitious foams have insufficient strength and bonding properties. There is therefore a need for cementitious foams having improved strength and bonding properties.

WO 01/70647 describes a process for producing a hydraulic binder foam. An aqueous foam is produced from water and a foam former, wherein the foam former comprises a hydrophilic polymer that is soluble, miscible or dispersible in water, preferably polyvinyl alcohol. The aqueous foam is mixed with a hydraulic binder in finely divided dry particle form to produce the hydraulic binder foam. The hydraulic binder foam may then be molded into a desired shape and the hydraulic binder is cured to afford the finished product.

U.S. Pat. No. 4,137,198 describes a polymer-inorganic hybrid foam which is usable as a building material and which comprises a continuous plastic phase or a substrate structure of non-expanded polymer, for example polyvinyl acetate, vinyl-acrylic copolymer or asphalt or bitumen pitch, wherein particles of an inorganic phase such as Portland cement particles are distributed therein, wherein this inorganic phase is substantially free of sand, stones or aggregate.

U.S. Pat. No. 6,586,483 relates to foaming compositions which include surface-modified nanoparticles.

U.S. Pat. No. 8,124,662 relates to a foamed polymer-inorganic binder having a controlled density and morphology, in particular a foamed polyurethane-inorganic binder, to a process for the production thereof and to the use thereof.

Guochen Sang et al. describe cementitious foams modified with an ethylene-vinyl acetate copolymer.

However, the foamed binders described in the prior art do not provide a solution for reducing the brittleness of cementitious foams while simultaneously improving strength and bonding properties.

The present invention accordingly had for its object to produce hybrid foams having low brittleness and improved strength and bonding properties.

This object is achieved by a hybrid foam according to the invention comprising
at least one mineral binder;
at least one polymer comprising monomer units deriving from at least one ethylenically unsaturated monomer or from a combination of polyisocyanates and polyols and/or polyamines;
a at least one surface-active substance;
at least one thickener;
optionally at least one further additive; and
water.

It has now been found that, surprisingly, a hybrid foam which comprises in addition to at least one mineral binder at least one polymer comprising monomer units deriving from at least one ethylenically unsaturated monomer or from a combination of polyisocyanates and polyols and/or polyamines and at least one surface-active substance exhibits reduced brittleness and improved strength and bonding properties. It is thought that the polymer proportion in the hybrid foam is responsible for the reduced brittleness. It is further thought that the at least one polymer present in the hybrid foam can absorb energy and thus achieve higher strengths, such as for example a higher impact strength. The at least one thickener present in the hybrid foam, for example a cellulose ether, results in a viscosity increase of the water and thus of the mortar mixture. In addition the thickener retards the drainage of the foamed mortar and improves water retention in the system. Additization with thickeners in principle results in increased stability.

The present invention further relates to a process for producing a hybrid foam. This comprises initially producing a mixture comprising at least one mineral binder, at least one polymer comprising monomer units deriving from at least one ethylenically unsaturated monomer or from a combination of polyisocyanates and polyols and/or polyamines, and water. This mixture is subsequently mixed with an aqueous foam comprising water and a surface-active substance to obtain the hybrid foam according to the invention. The obtained hybrid foam is then optionally cured. It is thought that the initial charging of a mixture comprising the binder, polymer and water and subsequent mixing (folding in) with an aqueous foam affords a particularly homogeneous hybrid foam. This ensures that the improved properties, namely reduced brittleness and improved strength and bonding properties, are produced homogeneously in the entire hybrid foam. Furthermore, the folding in of the foam ensures that at an appropriately adapted shear rate said foam may be nondestructively and homogeneously incorporated into the initially charged mixture comprising the binder, polymer and water.

The present invention further relates to a hybrid foam obtainable by the process according to the invention. Due to the structural properties obtained as a result of the process and due to its constituents the hybrid foam features a low brittleness and improved strength and bonding properties. The hybrid foam obtained by the process according to the invention is preferably also admixed with a thickener to further improve the strength properties of the hybrid foam.

The present invention further relates to the use of a hybrid foam according to the invention for bonding, filling and/or insulating.

The invention is more particularly described hereinbelow. The following terms are defined in this connection.

The term “% by weight” (also referred to as mass fraction) denotes the percentage of the respective component based on the sum of all components measured by weight unless otherwise stated. The term “% by volume” denotes the percentage of the respective component based on the sum of all components measured by volume unless otherwise stated. In addition the sum of all percentages of the specified and unspecified components of a composition is always 100%.

The term “comprising” is to be understood as meaning that not only the specifically recited features but also further not specifically recited features may be present. The term “consisting of” is to be understood as meaning that only the specifically recited features are present.

The preferred embodiments of the invention are elucidated hereinbelow. The preferred embodiments are preferred alone and in combination with one another.

As described hereinabove the invention relates to a hybrid foam comprising
at least one mineral binder;
at least one polymer comprising monomer units deriving from at least one ethylenically unsaturated monomer or from a combination of polyisocyanates and polyols and/or polyamines;
at least one surface-active substance;
at least one thickener;
optionally at least one further additive; and
water.

In a further embodiment the hybrid foam comprises
at least one mineral binder;
at least one styrene-acrylate copolymer;
at least one surface-active substance;
at least one thickener;
optionally at least one further additive; and
a water.

It has surprisingly been found that particularly good tensile bond strength values are achievable through the use of styrene-acrylate copolymer.

In a further embodiment the hybrid foam comprises
at least one mineral binder;
at least one polymer comprising monomer units deriving from at least one ethylenically unsaturated monomer or from a combination of polyisocyanates and polyols and/or polyamines;
at least one surface-active substance;
at least one cellulose ether;
optionally at least one further additive; and
water.

The use of cellulosic ethers is advantageous with regard to compressive strength.

In a further embodiment the hybrid foam comprises
at least one mineral binder;
at least one styrene-acrylate copolymer;
at least one surface-active substance;
at least one cellulose ether;
optionally at least one further additive; and
water.

According to the invention hybrid foam is to be understood as meaning a foam which comprises not only at least one mineral binder but also at least one polymer.

The hybrid foams according to the invention are biphasic or triphasic systems, wherein one phase is gaseous and one phase is solid and optionally one phase is liquid. The gaseous phase is in the form of fine gas bubbles separated by cell walls obtained from the liquid and solid phases. The cell walls meet at edges which in turn meet at node points, thus forming a scaffold. The content of the gaseous phase in the hybrid foam may vary in a range from 20% to 99% or 20% to 98% by volume, preferably from 50% to 98% by volume. The liquid phase is preferably an aqueous phase and the hybrid foam therefore typically also comprises water. However, after curing the water is in the form of a hydrate, i.e. has been bound by the mineral binder. The remaining water is preferably no longer present after a drying step so that the cured hybrid foam preferably retains only the gas phase and the solid phase, wherein this solid phase then forms the abovementioned cell walls. The solid phase of a hybrid foam according to the invention comprises at least one mineral binder and at least one polymer comprising monomer units deriving from at least one ethylenically unsaturated monomer or from a combination of polyisocyanates and polyols and/or polyamines. Solid/cured hybrid foams which are typically obtained after a drying step may be open-cell foams or closed-cell foams. In the case of closed-cell foams the gas is completely surrounded by the cell wall. For the same density closed-cell foams are typically more robust than open-cell foams. Closed-cell foams are accordingly preferred on account of their improved mechanical stability.

The gas phase present in the foam may be introduced by mechanical, physical or chemical foaming. Nonlimiting examples of gases comprise air, nitrogen, noble gas, carbon dioxide, hydrocarbons and mixtures thereof.

The gas phase present in the foam may be introduced by mechanical foaming in the presence of the respective gas. The mechanical foaming may be carried out using a kitchen mixer or by an oscillating process or by a rotor-stator method.

The gas phase may also be incorporated into the foam by physical or chemical foaming, wherein the physical or chemical foaming process is suitable for liberating a gas. It is preferable to employ blowing agents which react with water and/or an acid or decompose to liberate the gas. Nonlimiting examples of blowing agents are peroxides such as hydrogen peroxide, dibenzoyl peroxide, peroxobenzoic acid, peroxoacetic acid, alkali metal peroxides, perchloric acid, peroxomonosulfonic acid, dicumyl peroxide or cumyl hydroperoxide; isocyanates; carbonates and bicarbonates such as CaCO₃, Na₂CO₃ and NaHCO₃ which are preferably employed in combination with an acid, for example a mineral acid; metal powders such as aluminum powders; azides such as methyl azide; hydrazides such as p-toluenesulfonyl hydrazide; or hydrazine.

The foaming by a blowing agent may be promoted through use of a catalyst. Suitable catalysts preferably comprise Mn²⁺—, Mn⁴⁺—, Mn⁷⁺— or Fe³⁺ cations. It is alternatively possible to use the enzyme catalase as a catalyst. Nonlimiting examples of suitable catalysts are MnO₂ and KMnO₄. Such catalysts are preferably employed in combination with peroxide blowing agents.

The term “water” as used herein may relate to pure, deionized water or to water comprising up to 0.1% by weight of impurities and/or salts, such as normal mains water.

Mineral binders are inorganic compounds which cure in an aqueous environment (hydraulic) or in the presence of air (non-hydraulic). The hydraulic binders include inter alia cement, hydraulic lime, trass and pozzolans. Non-hydraulic binders include inter alia gypsum, air-curing lime, magnesium binders and loam. Mineral binders also include latently hydraulic binders such as microsilica, metakaolin, aluminosilicates, fly ashes, activated clay, pozzolans and mixtures thereof. A latently hydraulic binder becomes hydraulic only in the presence of a basic activator. The alkaline medium for activating the binders typically comprises aqueous solutions of alkali metal carbonates, alkali metal fluorides, alkali metal hydroxides, alkali metal aluminates and/or alkali metal silicates, for example soluble waterglass.

Cement is an inorganic, finely ground hydraulic binder. According to DIN EN 197-1 (November/2011) the different types of cement are classified into the categories CEM I-V. The term “cement” also includes calcium aluminate cements, calcium sulfoaluminate cements (CSA cements) and mixtures thereof.

CEM I cement, also known as Portland cement, comprises about 70% by weight of CaO and MgO, about 20% by weight of SiO₂, about 10% by weight of Al₂O₃ and Fe₂O₃. This cement is obtained by milling and kilning of limestone, chalk and clay. OEM II cement, also known as Portland composite cement, is Portland cement having a low (about 6% to about 20% by weight) or moderate (about 20% to about 35% by weight) amount of additional components. This cement may further comprise blast furnace slag, pyrogenic silica (not more than 10% by weight), natural pozzolans, natural calcined pozzolans, fly ash, calcined shale or mixtures thereof. CEM III cement, also known as blast furnace cement, consists of Portland cement comprising 36% to 85% by weight of slag. CEM IV cement, also known as pozzolan cement, comprises not only Portland cement but also 11% to 65% by weight of mixtures of pozzolans, silicas and fly ash. CEM V cement, also known as composite cement, comprises not only Portland cement but also 18% to 50% by weight of slag or mixtures of natural pozzolans, calcined pozzolans and fly ash. In addition the various cement types may comprise 5% by weight of additional inorganic, finely ground mineral compounds.

Calcium aluminate cements include minerals of the formula CaO x Al₂O₃. They can be obtained, for example, by melting calcium oxide (CaO) or limestone (CaCO₃) with bauxite or aluminate. Calcium aluminate cements comprise, for instance, 20% to 40% by weight of CaO, up to 5% by weight of SiO₂, about 40% to 80% by weight of Al₂O₃ and up to about 20% by weight of Fe₂O₃. Calcium aluminate cements are defined in the standard DIN EN 14647 (January/2006).

Calcium sulfoaluminate cements may be produced from tricalcium aluminate (3 CaO x Al₂O₃), anhydrite (CaSO₄), calcium sulfate hemihydrate (CaSO₄ x 0.5H₂O) and/or gypsum (CaSO₄ x 2H₂O). The preferred composition is essentially 3 CaO x Al₂O₃ x 3 CaSO₄.

The term gypsum comprises calcium sulfate dihydrate (CaSO₄ x 2H₂O), calcium sulfate hemihydrate (CaSO₄ x ½H₂O) and calcium sulfate anhydrite (CaSO₄). Natural gypsum is CaSO₄ x 2H₂O. However, calcined gypsum may exist in a multiplicity of hydration states according to general formula CaSO₄.x nH₂O, where 0≤n<2.

According to the invention “slaked lime” is to be understood as meaning calcium hydroxide.

In a preferred embodiment the mineral binder is a cement, slaked lime, gypsum or a mixture thereof.

The polymer present in the mineral hybrid foam may be employed as a dispersion or solid as desired, for example in the form of a powder, wherein in the case of a powder the polymer is in the form of particles, i.e. polymer particles.

The term “particles” or “polymer particles” relates to polymer particles having a particular particle size Dₓ based on a particle size distribution, wherein x % of the particles have a diameter less than the Dₓ value. The D₅₀ particle size is the median value of the particle size distribution. The particle size distribution can be measured, for example, by means of dynamic light scattering ISO 22412:2008. The particle size distribution can be reported as volume distribution, surface distribution or numerical distribution. According to the present invention, the Dₓ value relates to the numerical distribution, where x % of the total number of particles have a smaller diameter. The D₅₀ value of suitable polymer particles in the dispersed state is preferably in the range from 50 to 1000 nm. Due to a reversible agglomeration of the particles during drying, the D₅₀ of the particles in powder form is greater and a D₅₀ of 10 to 300 μm is preferred. The particle size measurement of polymer powders is based on optical dynamic digital image processing. A dispersed particle stream passes through two LED stroboscope light sources, with detection of the shadows projected by the particles by two digital cameras. The dry measurement is effected with the Camsizer XT instrument from Retsch GmbH using a dispersion pressure of 50 kPa.

The polymer particles are obtainable by bulk polymerization, solution polymerization, emulsion polymerization, suspension polymerization or precipitation polymerization. A suitable free-radical, anionic and/or cationic initiator may be employed. Suitable initiators are known to those skilled in the art.

The polymer particles are typically obtained by emulsion polymerization. This is a process for free-radical polymerization of hydrophobic monomers in an aqueous phase. Emulsifiers are preferably added to solubilize the hydrophobic monomers. Suitable emulsifiers comprise inter alia those having a polyoxyalkylene group. The emulsifiers added during the emulsion polymerization typically remain adherent to the surface of the polymer particles formed and the emulsifier is thus applied to the surface of the particles by the emulsion polymerization. A water-soluble initiator is also added to initiate the polymerization. Typical initiators comprise thermally decomposing free-radical formers, for example peroxides or azo compounds, photochemically decomposing free-radical formers, for example azobis(isobutyronitrile) (AIBN), or free-radical formers formed by redox reactions, for example the combination of ammonium peroxodisulfate and ascorbic acid.

If the polymer is obtained by emulsion polymerization the finished polymer in the aqueous phase may be employed directly as a polymer dispersion. The water may alternatively be removed and the polymer particles may be redispersed when for example the mineral binder, the polymer particles and water are mixed. Water is removed from polymer dispersions by drying. The drying can be effected by roller drying, spray drying, drying by a fluidized bed method, by bulk drying at elevated temperature, or other customary drying methods. The preferred range of the drying temperature is between 50° C. and 250° C. Freeze drying is alternatively also possible. Spray drying is particularly preferred. Preference is given to an entry temperature of the drying air in the range from 100° C. to 250° C., preferably 130° C. to 220° C., and an exit temperature in the range from 30° C. to 120° C., preferably 50° C. to 100° C. It is especially preferable when the entry temperature is in the range from 130° C. to 150° C. and the exit temperature is in the range from 60° C. to 85° C.

The term “polymer comprising monomer units deriving from at least one ethylenically unsaturated monomer” refers to a polymer originating from at least one ethylenically unsaturated monomer. In the polymerization the ethylenically unsaturated double bonds are converted into the polymer chain when for example a free radical breaks the C═C double bond (chain initiation) and the resulting radical having a C—C single bond attacks the closest ethylenically unsaturated monomer at the C═C double bond, and so forth, to form a polymer chain (chain growth reaction) until collision of two free radicals results in chain termination. The monomer units present in the polymer therefore correspond to the underlying ethylenically unsaturated monomers save for the fact that due to the polymerization the C═C double bonds are present only in the form of C—C single bonds and the monomer units are in a polymer chain.

The at least one ethylenically unsaturated monomer according to the present invention is preferably a compound having the following structural formula:

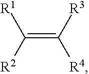

wherein R¹, R², R³ and R⁴ are independently selected from the group consisting of —H, —(C₁-C₆)alkyl, —O(C₁-C₆)alkyl, —COOR⁵, —(C₁-C₆)alkylCOOR⁵, —OC(O)(C₁-C₆)alkyl, —(C₂-C₆)alkenyl and —(C₆-C₁₀)aryl; and

wherein R⁵ is —(C₁-C₉)alkyl.

The prefix “Cₓ-C_{y}” denotes the possible number of carbon atoms in the particular group. The term “(C₁-C₉)alkyl” alone or as part of another group denotes a linear aliphatic carbon chain comprising 1 to 9 carbon atoms or a branched aliphatic carbon chain comprising 4 to 9 carbon atoms. The term “(C₁-C₆)alkyl” alone or as part of another group denotes a linear aliphatic carbon chain comprising 1 to 6 carbon atoms or a branched aliphatic carbon chain comprising 4 to 6 carbon atoms. Nonlimiting illustrative (C₁-C₉)alkyl groups or (C₁-C₆)alkyl groups include methyl, ethyl, n-propyl, isopropyl, n-butyl, 2-butyl, isobutyl, tert-butyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 2-ethylhexyl, 1,1,2-trimethylpropyl, 1,2,2-trimethylpropyl, 1-ethyl-1-methylpropyl, 1-ethyl-2-methylpropyl, n-octyl, isodecyl, 2-propylheptyl, cyclohexyl, isononyl, isotridecyl, isopentyl, 3,5,5-trimethyl-1-hexyl and 2-isopropyl-5-methylhexyl. The (C₁-C₆)alkyl group may optionally be substituted with one or more substituents independently selected from the group consisting of —F, —Cl, —OH and —CF₃.

The term “(C₂-C₆)alkenyl” denotes a linear or branched alkyl group having 2, 3, 4, 5 or 6 carbon atoms and having one, two or three carbon-carbon double bonds. In one embodiment the (C₂-C₆)alkenyl has one carbon-carbon double bond. Nonlimiting illustrative (C₂-C₆)alkenyl groups include vinyl (ethenyl), 1-propenyl, 1-butenyl, 2-butenyl, 3-butenyl, 1-pentenyl and 1-hexenyl. The (C₂-C₆)alkenyl group may optionally be substituted by one or more substituents independently selected from the group consisting of —F, —Cl, —OH and —CF₃.

The term “(C₆-C₁₀)aryl” denotes mono- or bicyclic aromatic compounds having 6 or 10 carbon atoms. Nonlimiting illustrative (C₆-C₁₀)aryl groups include phenyl and naphthyl. The (C₆-C₁₀)aryl group may optionally be substituted by one or more substituents independently selected from the group consisting of —F, —Cl, —OH and —CF₃, —(C₁-C₆)alkyl or —O(C₁-C₆)alkyl.

Auxiliary monomers are optionally also employable in subordinate amounts, for example less than 10% by weight, preferably less than 8% by weight, particularly preferably less than 6% by weight.

Examples of these further monomers are ethylenically unsaturated mono- and dicarboxylic acids, such as acrylic acid, methacrylic acid, itaconic acid, fumaric acid and maleic acid, aconitic acid, mesaconic acid, crotonic acid, citraconic acid, acryloyloxypropionic acid, methacryloyloxypropionic acid, vinylacetic acid, monomethyl itaconate, monomethyl fumarate, monobutyl fumarate, acrylic anhydride, methacrylic anhydride, maleic anhydride or itaconic anhydride, acrylamidoglycolic acid and methacrylamidoglycolic acid, acrylamide, methacrylamide and isopropylacrylamide, substituted (meth)acrylamides, for example N,N-dimethylamino(meth)acrylate; 3-dimethylamino-2,2-dimethylprop-1-yl (meth)acrylate, N,N-dimethylaminomethyl(meth)acrylamide, N-(4-morpholinomethyl)(meth)acrylamide, diacetoneacrylamide; acetoacethoxyethyl methacrylate; N-methylol(meth)acrylamide, polyethylene oxide (meth)acrylate, methoxy polyethylene oxide (meth)acrylate, acrolein, methacrolein; N-(2-methacryloyloxyethyl)ethyleneurea, 1-(2-(3-allyloxy-2-hydroxypropylamino)ethyl)imidazolidin-2-one, ureido(meth)acrylate, 2-ethyleneureidoethyl methacrylate.

The following auxiliary monomers are also suitable: ethylenically unsaturated, hydroxyalkyl-functional comonomers, such as hydroxy(C₁-C₅)alkyl methacrylates and acrylates such as hydroxyethyl, hydroxypropyl and 4-hydroxybutyl acrylate, hydroxyethyl (meth)acrylate and hydroxypropyl (meth)acrylates, 4-hydroxybutyl (meth)acrylate, glycidyl (meth)acrylate, and also N-vinylpyrrolidone and vinylimidazole.

Particular preference is given to acrylic acid, methacrylic acid, acrylamide, hydroxyethyl (meth)acrylate and hydroxypropyl (meth)acrylate.

Further examples of the auxiliary monomers are phosphorus-containing monomers, for example vinylphosphonic acid and allylphosphonic acid. Also suitable are the mono- and diesters of phosphonic acid and phosphoric acid with hydroxyalkyl (meth)acrylates, specifically the monoesters. Also suitable are diesters of phosphonic acid and phosphoric acid monoesterified with a hydroxyalkyl (meth)acrylate and additionally monoesterified with a different alcohol, for example an alkanol. Suitable hydroxyalkyl (meth)acrylates for these esters are those recited as separate monomers hereinbelow, in particular 2-hydroxyethyl (meth)acrylate, 3-hydroxypropyl (meth)acrylate and 4-hydroxybutyl (meth)acrylate. Corresponding dihydrogenphosphate ester monomers include phosphoalkyl (meth)acrylates such as 2-phosphoethyl (meth)acrylate, 2-phosphopropyl (meth)acrylate, 3-phosphopropyl (meth)acrylate, phosphobutyl (meth)acrylate and 3-phospho-2-hydroxypropyl (meth)acrylate. Also suitable are the esters of phosphonic acid and phosphoric acid with alkoxylated hydroxyalkyl (meth)acrylates, for example the ethylene oxide condensates of (meth)acrylates, such as H₂C═C(CH₃)COO(CH₂CH₂O)ₙP(OH)₂ and H₂C═C(CH₃)COO(CH₂CH₂O)ₙP(═O)(OH)₂, where n is 1 to 50. Also suitable are phosphoalkyl crotonates, phosphoalkyl maleates, phosphoalkyl fumarates, phosphodialkyl (meth)acrylates, phosphodialkyl crotonates and allyl phosphates. Further suitable monomers comprising phosphorus groups are described in WO 99/25780 and U.S. Pat. No. 4,733,005, hereby incorporated by reference.

Also suitable are vinylsulfonic acid, allylsulfonic acid, sulfoethyl acrylate, sulfoethyl (meth)acrylate, sulfopropyl acrylate, sulfopropyl (meth)acrylate, 2-hydroxy-3-acryloyloxypropylsulfonic acid, 2-hydroxy-3-methacryloyloxypropylsulfonic acid, styrenesulfonic acids and 2-acrylamido-2-methylpropanesulfonic acid. Suitable styrenesulfonic acids and derivatives thereof are styrene-4-sulfonic acid and styrene-3-sulfonic acid and the alkaline earth metal or alkali metal salts thereof, for example sodium styrene-3-sulfonate and sodium styrene-4-sulfonate, poly(allyl glycidyl ethers) and mixtures thereof, in the form of various products named Bisomer® from Laporte Performance Chemicals, UK. These are, for example, Bisomer® MPEG 350 MA, a methoxy polyethylene glycol monomethacrylate.

In a preferred embodiment, the polymer comprises monomer units formed from at least one ethylenically unsaturated monomer selected from the group consisting of ethylene, propylene, butadiene, styrene, vinyl acetate, vinyl chloride, acrylic esters, methacrylic esters and mixtures of the abovementioned monomers. A particularly preferred polymer, provided it is constructed from at least one ethylenically unsaturated monomer, is a copolymer selected from the group consisting of styrene-(meth)acrylate copolymers, styrene-butadiene copolymers, (meth)acrylate copolymers and ethylene-vinyl acetate copolymers. Provided it is constructed from at least one ethylenically unsaturated monomer the polymer is very particularly preferably a styrene(meth)acrylate copolymer or a (meth)acrylate copolymer, wherein “(meth)acrylate” represents (meth)acrylate and/or acrylate. Provided it is constructed from at least one ethylenically unsaturated monomer the polymer is most preferably a styrene-(meth)acrylate copolymer, in particular a styrene-acrylate copolymer.

The term “polymer comprising monomer units deriving from a combination of polyisocyanates and polyols and/or polyamines” refers to a polymer originating from at least one polyisocyanate monomer and at least one polyol and/or polyamine monomer. In the polyaddition polymerization, polyisocyanates are crosslinked with polyols and/or polyamines. Joining is effected by the reaction of an isocyanate group (—N═C═O) of one molecule with a hydroxyl group (—OH) or an amine group (—NH₂) of another molecule to form a urethane group (—NH—CO—O—) or a urea group (—NH—CO—NH—).

Suitable polyisocyanate monomers are compounds having two or more hydroxyl- and/or amine-reactive isocyanate groups. These comprise not only aromatic but also aliphatic isocyanates. Suitable polyisocyanates include 2,4-diisocyanatotoluene, 2,6-diisocyanatotoluene, methylenedi(phenyl isocyanate), polymeric methylenedi(phenyl isocyanate), bis(4-isocyanatocyclohexyl)methane, 1,3-bis(1-isocyanato-1-methylethyl)benzene (m-TMXDI), 1-isocyanato-5-isocyanatomethyl-3,3,5-trimethylcyclohexane, naphthylene diisocyanate, hexamethylene diisocyanate, 1,6-diisocyanatohexane, isophorone diisocyanate, diisocyanatodicyclohexylmethane and biuret triisocyanate. Industrial isomer mixtures of the individual aromatic polyisocyanates may likewise be employed. Also suitable in principle are the so-called “coating polyisocyanates” based on bis(4-isocyanatocyclohexyl)methane, 1,6-diisocyanatohexane, 1-isocyanato-5-isocyanatomethyl-3,3,5-trimethycyclohexane. The term “coating polyisocyanates” denotes allophanate-, biuret-, carbodimide-, isocyanurate-, uretdione-, urethane-containing derivatives of these diisocyanates in which the residual content of monomeric diisocyanates has been reduced to a minimum by prior art methods. Also employable in addition are modified polyisocyanates obtainable for example by hydrophilic modification of “coating polyisocyanates” based on 1,6-diisocyanatohexane.

Suitable polyol monomers are compounds having two or more isocyanate-reactive hydroxyl groups. Polyol monomers according to the invention also comprise polyether polyols and polyester polyols. Examples of polyol monomers are 1,2-ethanediol/ethylene glycol, 1,2-propanediol/1,2-propylene glycol, 1,3-propanediol/1,3-propylene glycol, 1,4-butanediol/1,4-butylene glycol, 1,6-hexanediol/1,6-hexamethylene glycol, 2-methyl-1,3-propanediol, 2,2-dimethyl-1,3-propanediol/neopentyl glycol, 1,4-bis(hydroxymethyl)cyclohexan/cyclohexanedimethanol, 1,2,3-propanetriol/glycerol, 2-hydroxymethyl-2-methyl-1,3-propanol/trimethylolethane, 2-ethyl-2-hydroxymethyl-1,3-propanediol/trimethylolpropane, 2,2-bis(hydroxymethyl)-1,3-propanediol and pentaerythritol.

Suitable polyamine monomers are compounds having two or more isocyanate-reactive amine groups. Examples of employable polyamine monomers are diethyltolylenediamine, methylbis(methylthio)phenylenediamine, adipic dihydrazide, ethylenediamine, diethylenetriamine, triethylenetetramine, tetraethylenepentamine, pentaethylenehexamine, dipropylenetriamine, hexamethylenediamine, hydrazine, isophoronediamine, N-(2-aminoethyl)-2-aminoethanol, polyoxyalkyleneamine, adducts of salts of 2-acrylamido-2-methylpropane-1-sulfonic acid (AMPS) and ethylenediamine, adducts of salts of (meth)acrylic acid and ethylendiamine, adducts of 1,3-propanesulfone and ethylenediamine or any desired combination of these polyamines.

Further suitable polyurethanes and the production thereof are described in the patent application DE 103 15 175 A.

In a particularly preferred embodiment the polymer according to the invention is selected from the group consisting of (meth)acrylate copolymers, styrene-acrylate copolymers, styrene-methacrylate copolymers, styrene-butadiene copolymers, styrene-2-ethylhexyl acrylate copolymers, styrene-n-butyl acrylate copolymers, polyurethanes, polyvinyl acetates and ethylene-vinyl acetate copolymers.

In a further particularly preferred embodiment the polymer is a styrene-(meth)acrylate copolymer, a styrene-butadiene copolymer, an ethylene-vinyl acetate copolymer or a polyurethane. The polymer is very particularly preferably a styrene-(meth)acrylate copolymer, in particular a styrene-acrylate copolymer.

The polymer may be in the form of a monopolymer (homopolymer) or a copolymer. The copolymers include random copolymers, gradient copolymers, alternating copolymers, block copolymers and graft copolymers. The copolymers are preferably in the form of linear random copolymers or of linear block copolymers.

The polymer preferably has an average (weight-average) molecular weight of less than 2 500 000 g/mol or less than 1 500 000 g/mol, more preferably of 50 000 to 1 500 000 g/mol. The average molecular weight may be determined as the weight-average by gel permeation chromatography, for example in THF. To this end the liquid polymer dispersion is dissolved in a large excess of tetrahydrofuran (THF), for example with a polymer concentration of 2 milligrams of polymer per milliliter of THF, and the insoluble component is removed with a 200 nm mesh size membrane filter.

The surface-active substances may be nonionic, anionic, cationic, zwitterionic and amphiphilic compounds and also proteins or mixtures thereof. Anionic surface-active substances are preferred.

Suitable anionic surface-active substances are diphenyleneoxide sulfonates, alkane and alkylbenzene sulfonates, alkylnaphthalene sulfonates, olefin sulfonates, alkyl ether sulfonates, alkyl sulfates, alkyl ether sulfates, alpha-sulfo fatty acid esters, acylaminoalkane sulfonates, acyl isethionates, alkyl ether carboxylates, N-acyl sarcosinates, alkyl and alkyl ether phosphates. Examples of suitable anionic surface-active substances are C₈-C₁₈-alkyl sulfates, C₈-C₁₈-alkyl ether sulfates, C₈-C₁₈-alkyl sulfonates, C₈-C₁₈-alkylbenzene sulfonates, C₈-C₁₈-α-olefin sulfonates, C₈-C₁₈-sulfosuccinates, α-sulfo-C₈-C₁₈-fatty acid disalts and C₈-C₁₈-fatty acid salts. The anionic surface-active substances are generally in the form of alkali metal salts, in particular in the form of sodium salts. Examples of sodium salts of anionic interface-active substances are sodium lauryl sulfate, sodium myristyl sulfate, sodium cetyl sulfate, sodium sulfates of ethoxylated lauryl or myristyl alcohol having an ethoxylation level of 2 to 10, sodium lauryl or cetyl sulfonate, sodium hexadecylbenzene sulfonate, sodium C₁₄/C₁₆-α-olefinsulfonate, sodium lauryl or cetyl sulfosuccinate, disodium 2-sulfolaurate or sodium stearate or mixtures thereof.

Employable nonionic surface-active substances include alkylphenol polyglycol ethers, fatty alcohol polyglycol ethers, fatty acid polyglycol ethers, fatty acid alkanolamides, block copolymers, amine oxides, glycerol fatty acid esters, sorbitan esters or alkyl polyglucosides. Examples of suitable nonionic surface-active substances are C₈-C₁₈-fatty alcohol ethoxylates, block copolymers of ethylene oxide and propylene oxide or C₈-C₁₈-alkyl polyglycosides or mixtures thereof. Examples of block copolymers are poloxamers. Poloxamers are block copolymers of ethylene oxide and propylene oxide, wherein preferred poloxamers comprise 2 to 130 ethylene oxide units and 10 to 70 propylene oxide units.

Examples of cationic surface-active substances are alkyltriammonium salts, alkylbenzyldimethylammonium salts or alkylpyridinium salts.

Employable proteins include both vegetable and animal proteins or mixtures thereof. Examples of suitable proteins are keratin, hydrolyzed keratin, collagen, hydrolyzed collagen or soy-based proteins.

In one embodiment the surface-active substances are selected from the group consisting of C₈-C₁₈-alkyl sulfates, C₈-C₁₈-alkyl ether sulfates, C₈-C₁₈-alkyl sulfonates, C₈-C₁₈-alkylbenzezene sulfonates, C₈-C₁₈-α-olefin sulfonates, C₈-C₁₈-sulfosuccinates, α-sulfo-C₈-C₁₈-fatty acids disalts, C₈-C₁₈-fatty acid salts, C₈-C₁₈-fatty alcohol ethoxylates, block copolymers of ethylene oxide and propylene oxide, C₈-C₁₈-alkyl polyglycosides, proteins and mixtures thereof.

Thickeners employable for the hybrid foam according to the invention include both organic and inorganic thickeners.

Suitable organic thickeners are selected from the group consisting of cellulose ethers, starch ethers and polyacrylamides. In a further embodiment the thickener is selected from polysaccharide derivatives and (co)polymers having a weight-average molecular weight Mw of more than 500 000 g/Mol, in particular more than 1 000 000 g/Mol.

In a further embodiment the thickener is selected from cellulose ethers, starch ethers and (co)polymers comprising structural units of nonionic (meth)acrylamide monomers and/or sulfonic acid monomers and optionally of further monomers. Cellulose ethers and starch ethers are preferred. Cellulose ethers are particularly preferred.

Suitable cellulose ethers are alkyl celluloses such as methylcellulose, ethylcellulose, propylcellulose and methylethylcellulose; hydroxyalkylcelluloses such as hydroxyethylcellulose (HEC), hydroxypropylcellulose (HPC) and hydroxyethylhydroxypropylcellulose; alkylhydroxyalkylcelluloses such as methylhydroxyethylcellulose (MHEC), methylhydroxypropylcelluose (MHPC) and propylhydroxypropylcellulose; and carboxylated cellulose ethers such as carboxymethylcellulose (CMC). Nonionic cellulose ether derivatives, in particular methylcellulose (MC), hydroxypropylcellulose (HPC), hydroxyethylcellulose (HEC) and ethylhydroxyethylcellulose (EHEC), are preferred and methylhydroxyethylcellulose (MHEC) and methylhydroxypropylcellulose (MHPC) are particularly preferred. The cellulose ether derivatives are in each case obtainable by appropriate alkylation and alkoxylation of cellulose as well as being commercially available.

Suitable starch ethers are nonionic starch ethers, such as hydroxypropyl starch, hydroxyethyl starch and methylhydroxypropyl starch. Hydroxypropyl starch is preferred. Suitable thickeners are also microbially produced polysaccharides such as welan gum and/or xanthans and naturally occurring polysaccharides such as alginates, carrageenans and galactomannanes. These may be obtained from corresponding natural products by extractive processes, for example from algae in the case of alginates and carrageenans and from carob kernels in the case of galactomannanes.

(Co)polymers having a weight-average molecular weight Mw of more than 500 000 g/mol, particularly preferably more than 1 000 000 g/mol, are producible from nonionic (meth)acrylamide monomers and/or sulfonic acid monomers (preferably by free-radical polymerization). In one embodiment the monomers are selected from acrylamide, methacrylamide, N-methylacrylamide, N-methylmethacrylamide, N,N-dimethylacrylamide, N-ethylacrylamide, N,N-diethylacrylamide, N-cyclohexylacrylamide, N-benzylacrylamide, N,N-dimethylaminopropylacrylamide, N,N-dimethylaminoethylacrylamide and/or N-tert.-butylacrylamide and/or styrenesulfonic acid, 2-acrylamido-2-methylpropansulfonic acid, 2-methacrylamido-2-methylpropansulfonic acid, 2-acrylamidobutansulfonic acid and/or 2-acrylamido-2,4,4-trimethylpentansulfonic acid or the salts of the recited acids. The (co)polymers preferably comprise more than 50 mol % and particularly preferably more than 70 mol % of structural units deriving from nonionic (meth)acrylamide monomers and/or sulfonic acid monomers. Other structural units that may be present in the copolymers are for example derived from the monomers (meth)acrylic acid, esters of (meth)acrylic acids with branched or unbranched C₁- to C₁₀-alcohols, vinyl acetate, vinyl propionate and/or styrene.

In a further embodiment the thickener is selected from methylcellulose, hydroxypropylcellulose, hydroxyethylcellulose, ethylhydroxyethylcellulose, hydroxypropyl starch, hydroxyethyl starch, methylhydroxypropyl starch, and (co)polymers comprising structural units derived from acrylamide, methacrylamide, N,N-dimethylacrylamide, 2-acrylamido-2-methylpropanesulfonic acid and optionally (meth)acrylic acid, esters of (meth)acrylic acids with branched or unbranched C₁-bis C₁₀-alcohols, vinyl acetate, vinyl propionate and/or styrene.

Suitable inorganic thickeners are phyllosilicates for example.

Various additives may also be employed according to the present invention. In a preferred embodiment the at least one additive is selected from the group consisting of pH modifiers, fillers, accelerators, retarders, rheology modifiers, superplasticizers, surfactants, hydrophobizing agents and mixtures thereof. In a particularly preferred embodiment the at least one additive is a hydrophobizing agent.

Rheology modifiers adjust viscosity and thus the flow characteristics and ensure a good balance between consistency, durability and performance. These modifiers may be based on synthetic polymers (for example acrylic polymers), cellulose, silicon dioxide, starches or clays.

Superplasticizers are polymers which act as dispersing agents to avoid particle segregation or to improve the rheology and thus the processability of suspensions. Super plasticizers may generally be assigned to one of the following categories: lignosulfonates, melamine sulfonates, naphthalene sulfonates, comb polymers (for example polycarboxylate ethers, polyaromatic ethers, cationic copolymers and mixtures thereof) and sulfonated ketone formaldehyde condensates. Preferred superplasticizers are naphthalene sulfonates or polycarboxylate ethers.

The setting time of the cementitious hybrid foam may be prolonged/reduced by addition of certain compounds known as retarders/accelerators. Retarders may be divided into the groups of lignosulfonates, cellulose derivatives, hydroxycarboxylic acids, organophosphates, synthetic retarders and inorganic compounds. Nonlimiting examples of retarders are hydroxyethylcellulose, carboxymethylhydroxyethylcellulose, citric acid, tartaric acid, gluconic acid, glucoheptonate, maleic anhydride, 2-acrylamido-2-methylpropanesulfonic acid (AMPS) copolymers, borax, boric acid and ZnO. Nonlimiting examples of accelerators are CaCl₂, KCl, Na₂SiO₃, NaOH, Ca(OH)₂ and CaO x Al₂O₃, lithium silicate, potassium silicate and aluminum salts such as aluminum sulfate.

The term “filler” relates primarily to materials that may be added to increase volume without impairing the properties of the cementitious hybrid foam. The recited fillers may be selected from the group consisting of quartz sand or quartz powder, calcium carbonate, stone flour, low-density fillers (for example vermiculite, perlite, diatomaceous earth, mica, talc powder, magnesium oxide, glass foam, hollow beads, sand foam, clay, polymer particles), pigments (for example titanium dioxide), high-density fillers (for example barium sulfate), metal salts (for example zinc salts, calcium salts etc.) and mixtures thereof. Particle sizes especially up to 500 μm are suitable. The average particle size of the glass foam is particularly preferably up to 300 μm.

Surfactants which may be used in addition to the surface-active substances as described hereinabove comprise nonionic surfactants, anionic surfactants, cationic surfactants, zwitterionic surfactants and proteins or synthetic polymers.

The term “pH-modifier” relates to an alkaline or acidic agent and includes mineral and organic acids and inorganic and organic bases.

Hydrophobizing agents may prevent the absorption of water, for example in the form of water vapor, into the hybrid foam. This allows damage caused by water penetrating into the hybrid foam to be prevented or at least reduced. Suitable hydrophobizing agents comprise silicones, fatty acids and waxes.

The hybrid foam according to the invention preferably further comprises limestone flour which improves processability and increases density/strength. Limestone flour comprises inter alia calcite and aragonite. Clay minerals, dolomite, quartz and gypsum may likewise further be present. The amount of limestone flour is preferably 0.1% to 90% by weight, more preferably 10% to 80% by weight and most preferably 20% to 75% by weight based on the total weight of the hybrid foam.

The amount of the mineral binder is by preference 10% to 98% by weight, preferably 25% to 75% by weight, based on the total weight of the hybrid foam.

The amount of the at least one polymer is by preference 1% to 25% by weight, preferably 2% to 15% by weight and most preferably 3% to 8% by weight based on the total weight of the hybrid foam. The polymer can be employed either as a powder or as a polymer dispersion. The abovementioned amounts relate to the solids content of the polymer. If the polymer is introduced into the hybrid foam in the form of a polymer dispersion the polymer solids content in the polymer dispersion is 1% to 50% by weight, preferably 10% to 40% by weight, based on the total weight of the polymer dispersion.

Based on the solids content of the mineral binder the amount of the at least one polymer is preferably 1% to 50% by weight, particularly preferably 4% to 30% by weight. The mineral binder and the at least one polymer are thus preferably present in the hybrid foam according to the invention in a ratio of 99:1 to 50:50, particularly preferably in a ratio of 96:4 to 70:30.

The amount of the at least one surface-active substance is preferably 0.01% to 2% by weight, more preferably 0.03% to 0.3% by weight and most preferably 0.05% to 0.1% by weight based on the total weight of the hybrid foam.

The amount of the thickener is preferably 0.01% to 1% by weight based on the total weight of the hybrid foam.

The amount of the optionally at least one additive is preferably 0.01% to 3% by weight, more preferably 0.05% to 1% by weight and most preferably 0.1% to 0.5% by weight based on the total weight of the hybrid foam.

In one embodiment the hybrid foam may further comprise at least one type of aggregates having a maximum particle size D₉₀ of 2 mm. As previously elucidated hereinabove particle size may be measured for example by dynamic light scattering ISO 22412:2008.

As previously mentioned hereinabove the invention further relates to a process for producing a hybrid foam comprising
(1) producing a mixture comprising
   at least one mineral binder;
   at least one polymer comprising monomer units deriving from at least one ethylenically unsaturated monomer or from a combination of polyisocyanates and polyols and/or polyamines;
   optionally at least one additive; and
   water;
(2) mixing the mixture obtained in step (1) with an aqueous foam comprising water and at least one surface-active substance; and
(3) optionally curing the hybrid foam obtained in step (2).

The abovementioned term definitions and examples and also the specified preferred substances and quantities are also preferred for the starting materials of the process for producing a hybrid foam.

In a preferred embodiment the mineral binder is a cement, slaked lime, gypsum or a mixture thereof.

In a preferred embodiment the at least one polymer is selected from the group consisting of (meth)acrylate copolymers, styrene-acrylate copolymers, styrene-methacrylate copolymers, styrene-butadiene copolymers, styrene-2-ethylhexyl acrylate copolymers, styrene-n-butyl acrylate copolymers, polyurethanes, polyvinyl acetates and ethylene-vinyl acetate copolymers. The polymer is particularly preferably a styrene-(meth)acrylate copolymer, in particular a styrene-acrylate copolymer.

In a preferred embodiment the at least one surface-active substance is selected from the group consisting of C₈-C₁₈-alkyl sulfates, C₈-C₁₈-alkyl ether sulfates, C₈-C₁₈-alkyl sulfonates, C₈-C₁₈-alkylbenzene sulfonates, C₈-C₁₈-α-olefin sulfonates, C₈-C₁₈-sulfosuccinates, α-sulfo-C₈-C₁₈-fatty acid disalts, C₈-C₁₈-fatty acid salts, C₈-C₁₈-fatty alcohol ethoxylates, block copolymers of ethylene oxide and propylene oxide, C₈-C₁₈-alkyl polyglycosides, proteins and mixtures thereof.

In a preferred embodiment the aqueous foam further comprises a thickener.

In a preferred embodiment the at least one thickener is selected from the group consisting of cellulose ethers, starch ethers and polyacrylamides. The at least one thickener is particularly preferably selected from the group consisting of cellulose ethers.

In a preferred embodiment the optional at least one additive is selected from the group consisting of pH modifiers, fillers, accelerators, retarders, rheology modifiers, superplasticizers, surfactants, hydrophobizing agents and mixtures thereof.

Process step (1) comprises producing a mixture comprising
at least one mineral binder;
at least one polymer comprising monomer units deriving from at least one ethylenically unsaturated monomer or from a combination of polyisocyanates and polyols and/or polyamines;
optionally at least one additive; and
a water.

Based on the solids content of the mineral binder the amount of the at least one polymer is preferably 1% to 50% by weight, particularly preferably 4% to 30% by weight. The mineral binder and the at least one polymer are accordingly preferably present in the hybrid foam according to the invention in a ratio of 99:1 to 50:50, particularly preferably in a ratio of 96:4 to 70:30.

The water content is reported as the ratio of water to the solids content of the mineral binder, hereinbelow also referred to as the water/binder value (w/b value). The w/b value is preferably 0.3-1.0 and particularly preferably 0.4-0.7.

The amount of the optionally employed at least one additive is preferably 0.01% to 3% by weight, more preferably 0.05% to 1% by weight and most preferably 0.1% to 0.5% by weight based on the solids content of the mineral binder.

Process step (2) comprises mixing the mixture obtained in step (1) with an aqueous foam comprising water and at least one surface-active substance.

The form is preferably folded into the mixture obtained in step (1).

The amount of the at least one surface-active substance is preferably 0.01% to 2% by weight, more preferably 0.03% to 0.3% by weight and most preferably 0.05% to 0.1% by weight based on the total weight of the aqueous foam.

It is preferable when the aqueous foam further comprises a thickener. In a preferred embodiment the amount of the thickener is 0.01% to 1% by weight based on the total weight of the aqueous foam.

The optional process step (3) comprises curing the hybrid foam obtained in step (2). 20 The optional curing of the hybrid foam is preferably carried out at 0° C. to 100° C. for at least 12 h.

As described hereinabove the invention further relates to a hybrid foam obtainable by the process according to the invention.

The invention further relates to the use of the hybrid foam according to the invention for bonding, filling and/or insulating.

The use of the hybrid foam according to the invention for the following applications is preferred in particular;
bonding mortar, for example EIFS bonding mortar (EIFS=exterior insulation and finishing system), wall bonding mortar (thin-bed mortar),
mortar for thermal insulation (for example insulating renders),
stucco, smoothing render and skim renders,
leveling underlayers and outerlayers, for example in screed,
acoustic foam (air-sound insulation).

The invention is more particularly described by the examples that follow.

### EXAMPLES

The production of a hybrid foam according to the invention is described by way of example hereinbelow.

Cement, limestone flour and cellulose ether are initially charged. Polycarboxylate ether, a polymer dispersion and water are then added to the initially charged dry mixture and mixed with a kitchen mixer for 110 seconds. This is followed by addition of an aqueous foam comprising a surface-active substance to the mixture via a foam generator, wherein the foam is folded into the mixture. The mixture is then again mixed with a kitchen mixer for a further 130 seconds to obtain a hybrid foam according to the invention.

For the investigations which follow all examples (save for the reference example 1) were produced in the manner described above. In a departure from the manner described above the reference example 1 was produced without foam addition and represents a classical EIFS bonding mortar as used in practice. The composition of the examples is reported in the table which follows. Unless otherwise stated the reported % by weight values relate to the total weight of the hybrid foam.

### Composition of Examples Produced

| | | Styrene | Styrene | Styrene- | | | |
|---|---|---|---|---|---|---|---|
| | Polyvinyl | acrylate | acrylate | butadiene | | | |
| | acetate | copolymer I | copolymer II | copolymer | Polyurethane | Cement | Limestone flour |
| | [% by wt.] | [% by wt.] | [% by wt.] | [% by wt.] | [% by wt.] | [% by wt.] | [% by wt.] |
| Ref. Ex. 1 | 2 | — | — | — | — | 73 | 24 |
| Ref. Ex. 2 | — | — | — | — | — | 73 | 24 |
| Ex. 1 | — | 3.5 | — | — | — | 73 | 24 |
| Ex. 2 | — | 7 | — | — | — | 73 | 24 |
| Ex. 3 | 3.5 | — | — | — | — | 73 | 24 |
| Ex. 4 | 7 | — | — | — | — | 73 | 24 |
| Ex. 5 | — | 7 | — | — | — | 25 | 75 |
| Ex. 6 | 7 | — | — | — | — | 25 | 75 |
| Ex. 7 | — | 7 | — | — | — | 50 | 50 |
| Ex. 8 | 7 | — | — | — | — | 50 | 50 |
| Ex. 9 | — | — | — | 3.5 | — | 73 | 24 |
| Ex. 10 | | | 3.5 | | | 73 | 24 |
| Ex. 11 | — | — | — | — | 3.5 | 73 | 24 |

The polyvinyl acetate dispersion comprises polyvinylacetate-co-ethylene. The dispersion has a solids content of 100% by weight, i.e. is in the form of a dispersion powder. The polymer has a glass transition temperature of 0° C.

The styrene-acrylate copolymer dispersion I comprises a styrene-butyl acrylate copolymer having a glass transition temperature of 19° C. As stabilizing auxiliary monomers acrylic acid and acrylamide are each employed in an amount of less than 2% by weight based on the total polymer amount calculated as solid. The dispersion has a solids content of 50% by weight. The polymer has a particle size of 120 nm.

The styrene-acrylate copolymer dispersion II comprises a styrene-butyl acrylate copolymer. The dispersion has a solids content of 51% by weight. As stabilizing auxiliary monomers acrylic acid and acrylamide are each employed in an amount of less than 2% by weight based on the total polymer amount, calculated as solid. The dispersion further comprises C12/14-fatty alcohol-ethoxylate-30-EO-sulfate in an amount of 3% by weight and C16/18-oxoalcohol-18 EO in an amount of 3% by weight. The polymer has a glass transition temperature of 19° C. and a particle size of 121 nm.

The styrene-butadiene copolymer dispersion comprises a styrene-butadiene copolymer. The dispersion has a solids content of 50% by weight. As stabilizing auxiliary monomers methacrylic acid and acrylamide are each employed in an amount of less than 2% by weight based on the total polymer amount, calculated as solid. The polymer has a glass transition temperature of −11° C. and a particle size of 175 nm.

The polyurethane dispersion comprises polyurethane. The dispersion has a solids content of 39.8% by weight. The polymer has a glass transition temperature of −35° C. and a particle size of 100 nm.

Unless otherwise stated the following ingredients were also added in all examples:
fatty alkyl ether sulfate, Na salt (C12/14+2EO-sulfate, Na salt) (surface-active substance) in an amount of 0.05% by weight based on the total weight of the hybrid foam;
polycarboxylate ether in an amount of 0.14% by weight based on the total weight of the hybrid foam;
cellulose ether in an amount of 0.02% by weight based on the total weight of the hybrid foam.

The flexural tensile strength and compression strength were determined on a cured prism according to DIN_EN_1015-11 and the curing time according to DIN_EN_1015-18 table 1 was used.

Tensile bond strength values and failure type were determined according to ETAG 004 6.1.4.1 on concrete slabs.

Tensile bond strength values on concrete slabs according to ETAG 004 6.1.4.1
a) conditions: 28 d under standard conditions (23° C./50% rel. humidity) (“28d” in table):
   threshold value according to standard: >=0.25 N/mm²
   conditions: 28 d under standard conditions (23° C./50% rel. humidity)+48 h immersion in water+2 h, 23° C./50% rel. humidity (“28d+2d wet” in table)
   threshold value according to standard: >=0.08 N/mm²
b) conditions: 28 d under standard conditions (23° C./50% rel. humidity)+48 h immersion in water+7 d, 23° C./50% rel. humidity (“28d+2d wet” in table):
   threshold value according to standard: >=0.25 N/mm²

The fresh bulk density (also wet density) was determined according to DIN-EN-1015-16. After 29 minutes the mixture was stirred for a further 15 seconds and after a further 45 seconds fresh bulk density was determined at 30 minutes. Dry density was determined according to EN1015-10 “determination of dry bulk densities of solid mortars” with the exception that establishment of a flow value according to 1015-2 table 2 was eschewed.

### Tensile Bond Strength Values on Concrete Slabs According to ETAG 004 6.1.4.1

| | | | | | Tensile |
|---|---|---|---|---|---|
| | | | | Tensile | strength |
| | | Tensile | Tensile | strength | 28 d + |
| | Dry | strength | strength | 28 d + | 2 d wet + |
| | density | 7 d | 28 d | 2 d wet | 7 d |
| | (kg/L) | (N/mm²) | (N/mm²) | (N/mm²) | (N/mm²) |
| Ref. | 1.38 | 0.621 | 0.661 | 0.435 | 0.832 |
| Ex. 1 | | | | | |
| Ref. | 0.56 | — (not | — (not | — (not | — (not |
| Ex. 2 | | measurable) | measurable) | measurable) | measurable) |
| Ex. 1 | 0.79 | 0.28 | 0.334 | 0.456 | 0.639 |
| Ex. 2 | 0.84 | 0.57 | 0.646 | 0.435 | 0.574 |
| Ex. 3 | 0.71 | 0.129 | 0.132 | 0.3 | 0.353 |
| Ex. 4 | 0.71 | 0.169 | 0.189 | 0.391 | 0.749 |

### Variation of Cement/Limestone Flour—Tensile Bond Strength Values on Concrete Slabs According to ETAG 004 6.1.4.1

| | | | | | Tensile |
|---|---|---|---|---|---|
| | | | | Tensile | strength |
| | | Tensile | Tensile | strength | 28 d + |
| | Dry | strength | strength | 28 d + | 2 d wet + |
| | density | 7 d | 28 d | 2 d wet | 7 d |
| | (kg/L) | (N/mm²) | (N/mm²) | (N/mm²) | (N/mm²) |
| Ref. Ex. 1 | 1.38 | 0.621 | 0.661 | 0.435 | 0.832 |
| Ex. 2 | 0.84 | 0.57 | 0.646 | 0.435 | 0.574 |
| Ex. 4 | 0.71 | 0.169 | 0.189 | 0.391 | 0.749 |
| Ex. 5 | 0.74 | 0.459 | 0.806 | 0.351 | 0.944 |
| Ex. 6 | 0.76 | 0.453 | 0.47 | 0.332 | 0.746 |
| Ex. 7 | 0.79 | 0.663 | 0.734 | 0.55 | 0.866 |
| Ex. 8 | 0.79 | 0.343 | 0.346 | 0.379 | 0.639 |

### Failure Type in Tensile Bond Strength Measurements

| | | | | | | Tensile | | Tensile | |
|---|---|---|---|---|---|---|---|---|---|
| | | Tensile | | Tensile | | strength | | strength | |
| | Dry | strength | | strength | | 28 d + 2 d | | 28 d + 2 d | |
| | density | 7 d | | 28 d | | wet | | wet + 7 d | |
| | (kg/L) | (N/mm²) | Failure type | (N/mm²) | Failure type | (N/mm²) | Failure type | (N/mm²) | Failure type |
| Ref. Ex. 1 | 1.38 | 0.621 | adhesive (0%), | 0.661 | adhesive (0%), | 0.435 | adhesive (60%), | 0.832 | adhesive (30%), |
| | | | cohesive (100%) | | cohesive (100%) | | cohesive (40%) | | cohesive (70%) |
| Ref. Ex. 2 | 0.56 | — | adhesive (−%). | — | — | — | — | — | — |
| | | | cohesive (−%) | | | | | | |
| Ex. 1 | 0.79 | 0.28 | adhesive (0%), | 0.334 | adhesive (0%), | 0.456 | adhesive (5%), | 0.639 | adhesive (5%), |
| | | | cohesive (100%) | | cohesive (100%) | | cohesive (95%) | | cohesive (95%) |
| Ex. 2 | 0.84 | 0.57 | adhesive (0%), | 0.646 | adhesive (10%), | 0.435 | adhesive (5%), | 0.574 | adhesive (8%), |
| | | | cohesive (100%) | | cohesive (90%) | | cohesive (95%) | | cohesive (92%) |
| Ex. 3 | 0.71 | 0.129 | adhesive (0%), | 0.132 | adhesive (3%), | 0.3 | adhesive (10%), | 0.353 | adhesive (10%), |
| | | | cohesive (100%) | | cohesive (97%) | | cohesive (90%) | | cohesive (90%) |
| Ex. 4 | 0.71 | 0.169 | adhesive (10%), | 0.189 | adhesive (0%), | 0.391 | adhesive (0%), | 0.749 | adhesive (35%), |
| | | | cohesive (90%) | | cohesive (100%) | | cohesive (100%) | | cohesive (65%) |
| Ex. 5 | 0.74 | 0.459 | adhesive (15%), | 0.806 | adhesive (10%), | 0.351 | adhesive (0%), | 0.944 | adhesive (0%), |
| | | | cohesive (85%) | | cohesive (90%) | | cohesive (100%) | | cohesive (100%) |
| Ex. 6 | 0.76 | 0.453 | adhesive (0%), | 0.47 | adhesive (0%), | 0.332 | adhesive (0%), | 0.746 | adhesive (0%), |
| | | | cohesive (100%) | | cohesive (100%) | | cohesive (100%) | | cohesive (100%) |
| Ex. 7 | 0.79 | 0.663 | adhesive (0%), | 0.734 | adhesive (0%), | 0.55 | adhesive (5%), | 0.866 | adhesive (3%), |
| | | | cohesive (100%) | | cohesive (100%) | | cohesive (95%) | | cohesive (97%) |
| Ex. 8 | 0.79 | 0.343 | adhesive (4%), | 0.346 | adhesive (0%), | 0.379 | adhesive (0%), | 0.639 | adhesive (5%), |
| | | | cohesive (96%) | | cohesive (100%) | | cohesive (100%) | | cohesive (95%) |

### Flexural Tensile Strengths and Compressive Strengths of Mortar Prisms (7d) According to DIN EN998-1

| | | | Flexural |
|---|---|---|---|
| | | | tensile |
| | Flexural | Compressive | strength/ |
| | tensile | strength | compressive |
| | strength at | at dry | strength ratio |
| | dry density | density of | at dry density |
| | of 0.6 kg/L | 0.6 kg/L | of 0.6 kg/L |
| | (N/mm²) | (N/mm²) | (N/mm²) |
| Ref. Ex. 2 | 0.60 | 3.15 | 0.19 |
| Example 9 | 0.89 | 2.18 | 0.41 |
| Example 3 | 0.83 | 3.50 | 0.24 |
| Example 10 | 1.07 | 3.79 | 0.28 |
| Example 1 | 0.89 | 3.87 | 0.23 |
| Example 11 | 0.78 | 3.57 | 0.22 |
| Example 2 | 1.21 | 3.99 | 0.30 |
| Example 4 | 0.99 | 4.43 | 0.22 |

### Flexural Tensile Strengths and Compressive Strengths (28d) of Mortar Prisms According to DIN EN998-1

| | | | Flexural |
|---|---|---|---|
| | | | tensile |
| | Flexural | Compressive | strength/ |
| | tensile | strength | compressive |
| | strength at | at dry | strength ratio |
| | dry density | density of | at dry density |
| | of 0.6 kg/L | 0.6 kg/L | of 0.6 kg/L |
| | (N/mm²) | (N/mm²) | (N/mm²) |
| Ref. Ex. 2 | 0.87 | 2.96 | 0.29 |
| Example 3 | 1.28 | 4.20 | 0.30 |
| Example 1 | 1.46 | 4.28 | 0.34 |
| Example 2 | 1.71 | 5.1 | 0.34 |
| Example 4 | 1.85 | 5.44 | 0.34 |

1: A hybrid foam, comprising:
at least one mineral binder;
at least one polymer comprising monomer units derived from at least one ethylenically unsaturated monomer or from a combination of a polyisocyanate and a polyol and/or a polyamine;
at least one surface-active substance;
at least one thickener;
optionally at least one further additive; and
water.

2: The hybrid foam of claim 1, wherein the at least one mineral binder is a cement, slaked lime, gypsum or a mixture thereof.

3: The hybrid foam of claim 1, wherein the at least one polymer is selected from the group consisting of a (meth)acrylate copolymer, a styrene-acrylate copolymer, a styrene-methacrylate copolymer, a styrene-butadiene copolymer, a styrene-2-ethylhexyl acrylate copolymer, a styrene-n-butyl acrylate copolymer, a polyurethane, polyvinyl acetate and an ethylene-vinyl acetate copolymer.

4: The hybrid foam of claim 1, wherein the at least one surface-active substance is selected from the group consisting of a C₈-C₁₈-alkyl sulfate, a C₈-C₁₈-alkyl ether sulfate, a C₈-C₁₈-alkyl sulfonate, a C₈-C₁₈-alkylbenzene sulfonate, a C₈-C₁₈-α-olefin sulfonate, a C₈-C₁₈-sulfosuccinate an α-sulfo-C₈-C₁₈-fatty acids disalt, a C₈-C₁₈-fatty acid salt, a C₈-C₁₈-fatty alcohol ethoxylate, a block copolymer of ethylene oxide and propylene oxide, a C₈-C₁₈-alkyl polyglycoside, a protein and mixtures thereof.

5: The hybrid foam of claim 1, wherein the at least one thickener is selected from the group consisting of a cellulose ether, a starch ether and a polyacrylamide.

6: The hybrid foam of claim 1, wherein the optional at least one further additive is selected from the group consisting of a pH modifier, a filler, an accelerator, a retarder, a rheology modifier, a superplasticizer, a surfactant, a hydrophobizing agent and mixtures thereof.

7: The hybrid foam of claim 1, wherein an amount of the at least one mineral binder is 10% to 98% by weight, based on a total weight of the hybrid foam and an amount of the at least one polymer is 1% to 25% by weight, based on the total weight of the hybrid foam.

8: A process for producing a hybrid foam, the process comprising:
(1) producing a mixture comprising
at least one mineral binder;
at least one polymer comprising monomer units derived from at least one ethylenically unsaturated monomer or from a combination of a diisocyanate and a diol and/or a diamine;
optionally at least one additive; and
water;
(2) mixing the mixture of (1) with an aqueous foam comprising water and at least one surface-active substance, to obtain a hybrid foam; and
(3) optionally curing the hybrid foam obtained in (2).

9: The process of claim 8, wherein the at least one mineral binder is a cement, slaked lime, gypsum or a mixture thereof.

10: The process of claim 8, wherein the at least one polymer is selected from the group consisting of a (meth)acrylate copolymer, a styrene-acrylate copolymer, a styrene-methacrylate copolymer, a styrene-butadiene copolymer, a styrene-2-ethylhexyl acrylate copolymer, a styrene-n-butyl acrylate copolymer, a polyurethane, a polyvinyl acetate and an ethylene-vinyl acetate copolymer.

11: The process of claim 8, wherein the at least one surface-active substance is selected from the group consisting of a C₈-C₁₈-alkyl sulfate, a C₈-C₁₈-alkyl ether sulfate, a C₈-C₁₈-alkyl sulfonate, a C₈-C₁₈-alkylbenzene sulfonate, a C₈-C₁₈-α-olefin sulfonate, a C₈-C₁₈-sulfosuccinate, an α-sulfo-C₈-C₁₈-fatty acid disalt, a C₈-C₁₈-fatty acid salt, a C₈-C₁₈-fatty alcohol ethoxylate, a block copolymer of ethylene oxide and propylene oxide, a C₈-C₁₈-alkyl polyglycoside, a protein and mixtures thereof.

12: The process of claim 8, wherein the aqueous foam further comprises at least one thickener.

13: The process of claim 12, wherein the at least one thickener is selected from the group consisting of a cellulose ether, a starch ether and a polyacrylamide.

14: The process of claim 8, wherein the optional at least one additive is selected from the group consisting of a pH modifier, a filler, an accelerator, a retarder, a rheology modifier, a superplasticizer, a surfactant, a hydrophobizing agent and mixtures thereof.

15: A hybrid foam obtainable by the process of claim 8.

16: A process for bonding, filling and/or insulating, the process comprising obtaining the hybrid foam of claim 1.

17: A process for bonding, filling and/or insulating, the process comprising obtaining the hybrid foam of claim 15.
